(19) United States
(12) Patent Application Publication
(10) Pub. No.: US 2026/0132075 A1
(43) Pub. Date: May 14, 2026

(54) ELECTROCHROMIC GLAZING

(71) Applicant: SAINT-GOBAIN GLASS FRANCE, COURBEVOIE (FR)

(72) Inventors: Anne PENILLARD, AUBERVILLIERS (FR); Pascal NAEL, AUBERVILLIERS (FR); Nicolas CHEMIN, AUBERVILLIERS (FR); Denis GUIMARD, AUBERVILLIERS (FR); Amaury PATISSIER, AUBERVILLIERS (FR)

(21) Appl. No.: 19/120,623

(22) PCT Filed: Oct. 10, 2023
(86) PCT No.: PCT/FR2023/051573

§ 371 Date: Apr. 11, 2025

(30) Foreign Application Priority Data
Oct. 13, 2022 (FR) FR2210517

(51) Int. Cl. C03C 17/36

(52) U.S. Cl. CPC C03C 17/366; C03C 17/3626; C03C 17/3644; C03C 17/3649; C03C 17/3681; C03C 2217/216; C03C 2217/231; C03C 2217/24; C03C 2217/256; C03C 2217/261; C03C 2217/948; C03C 2218/156

(57) ABSTRACT

A material includes a substrate coated with a first conductive coating including, starting from the substrate a first dielectric coating, a silver-based metal functional functional layer, a blocking layer located above and immediately in contact with a silver-based metal functional layer, the blocking layer being chosen from metal layers of one or more elements chosen from nickel and chromium such as Ni, Cr, NiCr, and metal nitride layers of one or more elements chosen from titanium, nickel and chromium such as NiN, CrN, NiCrN, TiN, and a second dielectric coating including at least one conductive oxide layer, the sum of the thicknesses of the conductive oxide layers of the second dielectric coating being greater than 40 nm.

The present invention relates to the field of electrochromic (EC) glazings. The invention relates in particular to an electrically conductive coating for an electrochromic device comprising a silver-based metal functional layer with improved electrochemical properties.

Electrochromic devices, and in particular electrochromic glazings, are systems capable of modulating their optical response, in the visible or infrared range, under the action of an electrical voltage, thus making it possible to obtain easily adjustable electrically controlled coatings.

Electrochromic devices are known to feature an electrochromic system comprising a succession of at least five layered elements essential to the operation of the device, that is to the reversible color change following the application of an appropriate electrical power. These five layered elements are:
a first transparent electrically conductive coating,
a first active layer acting as an electrode,
an electrolyte layer,
a second active layer acting as a counter-electrode, and
a second transparent electroconductive coating.

At least one active layer is based on an electrochromic material.

These five layered elements are generally in contact with one or two transparent substrates.

Electrochromic systems come in three categories:
“all-solid” inorganic technology,
“hybrid” technology,
“all-polymer” technology.

In “all-solid” electrochromic systems, all layers are made of solid inorganic materials. These systems may comprise a single substrate. Examples of all-solid EC systems are described in patent applications EP-867 752, EP-831 360, WO 00/57243 and WO 00/71777.

Hybrid electrochromic systems comprise inorganic active layers framing an electrolyte layer based on an ion-conducting polymer. These systems traditionally comprise two substrates framing the electrochromic system. Examples of hybrid EC systems are described in patent applications EP-382 623, EP-518 754 and EP-532 408.

In “all-polymer” electrochromic systems, the active layers and electrolyte layer are polymer-based.

The phenomenon of coloration/discoloration in the visible range, or changes in optical properties more generally, results from a transfer of charge (ions/electrons) between the two active layers.

An active layer based on an electrochromic material is capable of reversibly inserting ions. When ions migrate to this layer, its optical properties change, and it reversibly passes from a discolored to a colored state. The other active layer can also be based on an electrochromic material.

Inorganic electrochromic materials are mostly transition metal oxides, grouped into two families: cathodically colored oxides, such as tungsten oxide WO₃, which are colored in the reduced state, and anodically colored oxides, such as iridium oxide (IrOx) and nickel oxide (NiOx), which are colored in the oxidized state. Pairs of cathodic and anodic electrochromic materials are generally chosen, with, for example, a cathodic material that becomes colored in the inserted state in association with an anodic material that becomes discolored in the inserted state.

The electrolyte layer must have good ionic conductivity and be electronically insulating. The electrolytes in the electrochromic system ensure the passage of mobile ions within their electrochemical stability range. In theory, all monovalent ions, such as H+, Li+, Na+, K+, Ag+, divalent ions such as Zn²⁺ and trivalent ions such as Al³⁺ can be used. Lithium, alkaline or hydrogen salts are particularly suitable.

For example, when a tungsten oxide (WO₃) active layer is in contact with a lithium ion-conducting electrolyte layer, Li⁺ ions are transferred between the electrodes when a voltage is applied. The following electrochemical reaction is observed at the cathode: W⁶⁺O²⁻₃ (transparent)+x Li⁺+x e⁻→Li⁺ₓW⁶⁺₁₋ₓW⁵⁺ₓO²⁻₃ (blue).

Voltammetry can be used to determine the voltage ranges that provide the best contrast between colored and discolored states. Voltammetric cycles or curves or voltammograms (j=f(V)) consist in tracking the variation in current density j over the scanned interval of potential. The study of current density variations is significant for the electrochemical behavior of materials. The coloring potentials (Vcoloration), the discoloring potentials (Vdiscoloration) of the material corresponding to oxidation reactions in the anodic part (j>0) or reduction reactions in the cathodic part of the curve (j<0), and the stability ranges can be deduced directly from these curves.

If we consider an electrochromic device comprising a cathodically colored active layer based on tungsten oxide and an electrolyte layer comprising lithium ions, we observe a colored state at 2.3 V and a discolored state at 3.2 V (vs. Li/Li+).

If we consider an electrochromic device comprising an anodically colored active layer based on nickel oxide and an electrolyte layer comprising lithium ions, the oxidation potential associated with lithium ion deinsertion is around 4 V while the discoloration voltage can be adjusted by doping the nickel oxide between 1V and 2.5 V.

Looking at known all-polymer EC systems comprising an electrolyte layer including lithium ions, the voltage range between a less transparent state and a more transparent state is between 2V and 4V vs Li/Li+.

Consequently, for these EC systems, the reactions enabling coloration and discoloration take place within a potential window of between 1V and 4V. The materials making up the various layered elements of the electrochromic system must have electrochemical stability ranges greater than the potential windows required to obtain the coloration/discoloration phenomena.

The “voltage stability range” of a material is the potential range to which a material can be exposed without undergoing an oxidation or reduction reaction.

When a material is subjected to an electrochemical potential outside its stability range and in the presence of the corresponding ions, a redox reaction occurs.

In the case of electrochromic systems, the electrically conductive coatings are exposed to the electrochemical potentials of the active materials with which they are in contact. This means that the electroconductive coatings of the electrochromic device must be stable within the potential window 2V to 4V, or even 1V to 4V vs Li/Li+. Electrically conductive coatings should therefore have an electrochemical stability range relative to the Li+/Li couple, preferably between 1V and 4V. The materials making up these conductive coatings must not undergo any oxidation-reduction reaction in this voltage range.

Known electrically conductive coatings include conductive functional layers based on transparent conductive oxide, such as indium-tin layers or fluorine-doped tin layers, or metal functional layers, particularly silver-based.

Electrically conductive coatings based on conductive oxide layers, while offering excellent electrochemical stability, do not have sufficient conductive properties at high light transmission (>80%). This results in inhomogeneous switching and/or a switching speed that decreases as the surface area of the EC system increases. Finally, in some applications, such as automotive applications, additional processing steps such as hardening or curving are sometimes required. These additional steps are likely to alter conductive oxide coatings. These coatings do need to be thick to achieve the desired resistivity values. However, such thick coatings are sensitive to cracking during heat treatment.

Conductive coatings with a silver-based metal functional layer offer superior electrical conductivity and high transparency. However, the low electrochemical stability of the silver functional layer limits the use of this type of conductive coating in electrochromic devices. In particular, silver-based conductive coatings undergo oxidation-reduction reactions with respect to the Li/Li+ couple in the 1V-4V range. At low potential, for a silver-based coating these reactions result in the reduction of Ag material, the formation of metal alloys (such as LiAg), or the production of reduced gas (dihydrogen). At high potential, these reactions lead to oxidation of the Ag+ material, the formation of oxide (AgO) and/or the production of oxidized gas (dioxygen). In the context of high-potential reactions, it is also possible to speak of the “corrosion” of materials.

Known electrically conductive coatings of this type include:
optionally a first dielectric layer or first dielectric coating,
a silver-based metal layer,
optionally a blocking layer,
a second dielectric layer or coating.

Cyclic voltammograms were produced to determine the voltage stability range of these electroconductive coatings, using a three-electrode set-up with a lithium metal counter-electrode, a lithium metal reference electrode, and a working electrode containing the electroconductive coating to be tested. The electrolyte is a LiClO4/PC solution. The working electrode comprises a 2 mm glass substrate coated with a known silver-based electroconductive coating comprising, starting from the substrate, the sequence (SiN/SnZnO/ZnO doped Al/Ag). The voltammogram was taken in the potential window from 2 to 4 V with respect to Li/Li+ at a scan rate of 2 mV/s.

No oxidation reaction is observed between 2 V and 3.4 V. A slight increase in current density is observed around 3.4 V vs Li/Li+, followed by a sharp increase around 3.7 V vs Li/Lit. This sharp increase is due to the oxidation of metallic Ag into Ag⁺ ions, which dissolve in the electrolyte. This demonstrates that such conductive coatings cannot be used in electrochromic devices unless the accessible contrast of the EC device is limited by imposing potentials below 3.7 V. In this case, no complete coloration or discoloration is obtained.

In order to benefit from the improved optical and conductive properties of silver-based electroconductive coatings in electrochromic devices, it is necessary to extend their electrochemical stability range.

The present invention concerns an electrically conductive coating comprising a silver-based metal functional layer with improved electrochemical stability. The coating of the invention is particularly suitable for use in electrochromic devices.

The applicant has discovered that the use of certain blocking layers in combination with a thick conductive oxide layer results in improved electrochemical stability, particularly around 3.7V vs Li/Li+. This improvement in electrochemical stability makes the agent-based conductive coating suitable for EC applications.

The invention relates to a material comprising a substrate coated with a first conductive coating comprising, starting from the substrate:
a first dielectric coating,
a silver-based metal functional layer,
a blocking layer located above and immediately in contact with a silver-based metal functional layer, said blocking layer being chosen from metal layers of one or more elements chosen from nickel and chromium such as Ni, Cr, NiCr, and metal nitride layers of one or more elements chosen from titanium, nickel and chromium such as NiN, CrN, NiCrN, TIN,
a second dielectric coating comprising at least one conductive oxide layer whose sum of conductive oxide layer thicknesses is greater than 40 nm, preferably 50 nm.

The invention increases the stability range of the silver-based electroconductive coating above 3.7 V compared with Li/Li+.

The invention also relates to a conductive coating comprising a silver-based, preferably transparent, metal functional layer that is electrochemically stable in the potential window of 2 to 4 V with respect to Li/Li+. The conductive coating comprises:
a silver-based metal functional layer,
a blocking layer located above and immediately in contact with a silver-based metal functional layer, said blocking layer being chosen from metal layers of one or more elements chosen from nickel and chromium such as Ni, Cr, NiCr, and metal nitride layers of one or more elements chosen from titanium, nickel and chromium such as NiN, CrN, NiCrN, TiN.

Thanks to this particular coating structure, it is possible to obtain a transparent conductive coating with electrochemical resistance compatible with EC systems, while at the same time having high electrical conductivity properties.

The invention also relates to a material with the following characteristic(s):
the blocking layer has a thickness of between 0.1 and 5.0 nm,
the blocking layer is selected from a titanium nitride layer, nickel-based metal layers and/or chromium-based metal layers,
the blocking layer is selected from nickel-based metal layers comprising at least 20% by mass of nickel relative to the mass of the nickel-based metal layer,
the second dielectric coating comprises a conductive oxide layer selected from tin indium mixed oxide or zinc oxide doped with aluminum and/or gallium,
the second dielectric coating comprises a conductive oxide layer based on aluminum-doped zinc oxide with a thickness greater than 50 nm,
the first dielectric coating comprises at least one crystallized dielectric layer, in particular based on zinc oxide, optionally doped with at least one other element, such as aluminum,
the first dielectric coating comprises a layer based on aluminum and/or zirconium silicon nitride or oxynitride, and/or a layer based on zinc oxide and tin,
the substrate is made of glass, in particular soda-lime-silica glass, or of polymeric organic material,
the material further comprises a first active layer comprising an electrochromic material located in contact with the electrically conductive coating,
the material further comprises an electrolyte layer located in contact with the first active layer comprising an electrochromic material, preferably the electrolyte is a lithium ionic conduction electrolyte,
the material further comprises a second active layer in contact with the electrolyte layer,
the material further comprises a second electroconductive coating located in contact with the electrolyte layer.

The invention also relates to an electrochromic system comprising:
a material according to the invention,
a first active layer comprising an electrochromic material,
an electrolyte layer,
a second active layer and
a second transparent electroconductive coating,
optionally a substrate.

The electrochromic material of active layers can be based on inorganic material such as tungsten oxide, nickel oxide, iridium oxide, cerium oxide or organic material such as electronically conductive polymers like polyaniline or (poly(3,4-ethylenedioxythiophene)) (PEDOT) or Prussian blue. These materials can insert cations, in particular protons or lithium ions.

The electrochromic material of the first active layer can be based on an oxide of an element chosen from tungsten, nickel, iridium, chromium, iron, cobalt or rhodium, or on a mixed oxide of at least two of these elements, in particular mixed nickel and tungsten oxide. It is preferably based on tungsten oxide.

The electrochromic material of the second active layer or counter-electrode is preferably based on an oxide of an element chosen from tungsten, nickel, iridium, chromium, iron, cobalt or rhodium, or on a mixed oxide of at least two of these elements, in particular mixed nickel and tungsten oxide. It is preferably based on nickel oxide or iridium oxide (anodic electrochromic material).

If the electrochromic material of the first active layer is tungsten oxide, that is a cathodic electrochromic material, whose colored state corresponds to the most reduced state, an anodic electrochromic material based on nickel or iridium oxide can be used for the counter-electrode, for example. In particular, this may be a layer of mixed vanadium-tungsten oxide or mixed nickel-tungsten oxide.

The thickness of the active layers is generally between 50 nm and 600 nm, particularly between 150 nm and 250 nm.

The thickness of the electrolyte layer can be between 1 nm and 1 mm. When the electrolyte layer is made of inorganic material, its thickness is preferably between 1 and 300 nm, between 1 and 50 nm or between 1 and 10 nm. When the electrolyte layer is made of polymer material, the thickness thereof is preferably between 100 and 800 μm, or between 100 and 500 μm.

The two electrically conductive coatings must be connected to their respective power supply connectors. These connectors, e.g. busbar and wires, are respectively brought into contact with the transparent conductive coatings to provide the appropriate power supply.

The invention also relates to an electrochromic system comprising two substrates held together by a frame.

Throughout the description, the substrate according to the invention is regarded as laid horizontally. The electroconductive coating is deposited above the substrate. The meaning of the expressions “above” and “below” and “lower” and “upper” is to be considered with respect to this orientation. Unless specifically stipulated, the expressions “above” and “below” do not necessarily mean that two layers and/or coatings are positioned in contact with one another. When it is specified that a layer is deposited “in contact” with another layer or with a coating, this means that there cannot be one (or several) layer(s) inserted between these two layers (or layer and coating).

All the light characteristics presented in the description are obtained according to the principles and methods described in the European standard EN 410 relating to the determination of the light and solar characteristics of the glazings used in glass for the construction industry.

The preferred characteristics which appear in the remainder of the description are applicable both to the material according to the invention and, where appropriate, to the glazing or to the system according to the invention.

The electroconductive coating is deposited by magnetic-field-assisted cathode sputtering (magnetron method). According to this advantageous embodiment, all the layers of coating are deposited by magnetic-field-assisted cathode sputtering.

Unless otherwise mentioned, the thicknesses referred to in the present document are physical thicknesses.

The present invention is suitable for single-layer silver-based functional coatings. This solution is also suitable for multi-layer silver-based functional coatings, in particular two or three functional layers. The coating comprises at least one or only one silver-based metal functional layer.

The silver-based metal functional layer comprises, before or after heat treatment, at least 95.0%, preferably at least 96.5% and better still at least 98.0% by weight of silver relative to the weight of the functional layer.

Preferably, the silver-based metal functional layer before heat treatment comprises less than 1.0% by weight of metals other than silver, with respect to the weight of the silver-based metal functional layer.

The term “metal layer” refers to a layer comprising no more than 30%, 20% or 10% oxygen and/or nitrogen by atomic percentage in the layer.

The purpose of the blocking layers is to improve the electrochemical properties of the silver layers.

When these blocking layers are deposited in metal or nitride form, these layers can undergo a partial or complete oxidation according to their thickness and the nature of the layers which surround them, for example, during the deposition of the following layer or by oxidation in contact with the underlying layer.

Advantageously, the blocking layers are metallic layers based on nickel. The metal blocking layers based on nickel may comprise (before heat treatment) at least 20%, at least 30%, at least 40%, at least 50%, at least 60%, at least 70%, at least 80%, at least 90%, at least 95%, at least 96%, at least 97%, at least 98%, at least 99% or 100% by weight of nickel relative to the weight of the nickel-based metallic layer.

The nickel-based metallic layers may be selected from:
nickel metal layers,
doped nickel metal layers,
nickel alloy-based metal layers.

The metallic layers based on a nickel alloy can be based on a nickel-chromium alloy.

The blocking layers can also advantageously be titanium nitride layers.

Each blocking layer has a thickness of between 0.1 and 5.0 nm. The thicknesses of these blocking layers may be:
at least 0.1 nm, at least 0.2 nm, at least 0.5 nm and/or
at most 5.0 nm, at most 4.0 nm, at most 3.0 nm, or at most 2.0 nm.

The electroconductive coating comprises at least one functional layer and at least two dielectric coatings comprising at least one dielectric layer, so that each functional layer is placed between two dielectric coatings.

“Dielectric coating” within the meaning of the present invention should be understood as meaning that there may be just one layer or several layers of different materials inside the coating. A “dielectric coating” according to the invention predominantly comprises dielectric layers. However, according to the invention, these layers can also comprise layers of another nature, particularly absorbent layers, for example absorbent metal layers.

It is considered that the “same” dielectric layer is located:
between the substrate and the first functional layer,
between each silver-based metal functional layer,
above the last functional layer (furthest from the substrate).

“Dielectric layer” within the meaning of the present invention should be understood as meaning that, from the perspective of its nature, the material is “nonmetallic”, that is, is not a metal. In the context of the invention, this term denotes a material having an n/k ratio, over the whole visible wavelength range (from 380 nm to 780 nm) of equal to or greater than 5. n denotes the real refractive index of the material at a given wavelength and k represents the imaginary part of the refractive index at a given wavelength; the ratio n/k being calculated at a given wavelength which is identical for n and for k.

The thickness of a dielectric coating corresponds to the sum of the thicknesses of the layers constituting it.

The coatings have a thickness of greater than 15 nm, preferably between 15 and 200 nm.

The dielectric layers of the coatings exhibit the following characteristics, alone or in combination:
they are deposited by sputtering assisted by a magnetic field,
they are selected from the oxides or nitrides of one or more elements chosen from titanium, silicon, aluminum, zirconium, tin, indium and zinc,
they have a thickness greater than 2 nm, preferably between 2 and 100 nm

The dielectric coating above the silver-based metal functional layer must be sufficiently conductive for the electrically conductive coating to retain its electrode function.

The dielectric coating above the silver-based metal functional layer comprises at least one conductive oxide layer. The conductive oxide layers are selected from mixed tin and indium oxide, indium oxide doped with tin (ITO “Indium Tin Oxide”), doped zinc oxide such as zinc oxide doped with aluminum (AZO) and/or gallium, doped ruthenium oxide and fluorine-doped tin oxide (SnO2:F).

Preferably, indium tin oxide (ITO) or zinc oxide doped with aluminum and/or gallium is used.

The sum of the thicknesses of all conductive oxide layers in the dielectric coating directly above the silver-based functional layer is greater than 50 nm or greater than 60 nm.

The sum of the thicknesses of all conductive oxide layers in the dielectric coating directly above the silver-based functional layer is less than 150 nm, less than 100 nm or less than 80 nm.

Preferably, the dielectric coating directly above the silver-based functional layer comprises at least one conductive oxide layer thicker than 50 nm or 60 nm.

Preferably, the dielectric coating directly above the silver-based functional layer comprises at least one conductive oxide layer based on aluminum-doped zinc oxide thicker than 50 nm or 60 nm. The combination of a blocking layer according to the invention with a thick conductive oxide layer based on doped zinc oxide gives the best results in terms of electrochemical stability.

In one embodiment, the dielectric coating may comprise at least two layers, a layer of aluminum-doped zinc oxide and a layer of mixed indium tin oxide (ITO).

According to the invention, indium tin oxide (ITO) is a mixed oxide or mixture obtained from indium (III) oxide (In2O3) and tin (IV) oxide (SnO2), preferably in mass proportions of between 70 and 95% for the first oxide and 5 to 20% for the second oxide. A typical mass ratio is around 90% In2O3 to around 10% SnO2.

According to the invention, the zinc oxide-based conductive oxide layer may comprise at least 50%, at least 60%, at least 70%, at least 80%, at least 90%, or at least 95% by mass of zinc compared to the mass of all elements forming the zinc oxide-based layer excluding oxygen and nitrogen. To be sufficiently conductive, zinc oxide-based layers are doped with at least one other element, known as a “doping element”. The layers based on zinc oxide may therefore comprise one or more doping elements selected from aluminum, titanium, niobium, zirconium, magnesium, copper, silver, gold, silicon, molybdenum, nickel, chromium, platinum, indium, tin and hafnium, preferably aluminum.

The conductive layers based on doped zinc oxide may comprise:
at least 1%, at least 2%, or at least 5%, and/or
at most 15% or at most 10%,
   by weight of doping elements relative to the total weight of all the elements forming the layer based on zinc oxide, excluding oxygen and nitrogen.

The dielectric coating beneath the silver-based metal functional layer need not be conductive. Advantageously, it may comprise a crystallized layer, also known as a stabilizing or wetting layer. A stabilizing layer is understood to mean a layer made of a material capable of stabilizing the interface with the functional layer. These layers are generally based on zinc oxide.

Zinc oxide-based layers may comprise at least 50%, at least 60%, at least 70%, at least 80%, at least 90%, at least 95%, at least 96%, at least 97%, at least 98%, at least 99%, or 100% by mass of zinc compared to the total mass of all elements forming the zinc oxide-based layer other than oxygen and nitrogen.

In order to be correctly crystallized by magnetron sputtering, the zinc oxide-based layers advantageously comprise at least 80% or even 90% by mass of zinc, relative to the total mass of all the elements constituting the zinc oxide layer, excluding oxygen and nitrogen.

The layers based on zinc oxide may comprise one or more elements selected from aluminum, titanium, niobium, zirconium, magnesium, copper, silver, gold, silicon, molybdenum, nickel, chromium, platinum, indium, tin and hafnium, preferably aluminum.

The layers based on zinc oxide may optionally be doped by means of at least one other element, such as aluminum.

The zinc-oxide-based layer comprises, in increasing order of preference, at least 80%, at least 90%, at least 95%, at least 98%, at least 100% by weight of oxygen relative to the total weight of oxygen and nitrogen.

Preferably, the dielectric coating located directly below the silver-based metal functional layer comprises at least one crystallized dielectric layer, in particular based on zinc oxide, optionally doped using at least one other element, such as aluminum.

These zinc oxide layers have a thickness of:
at least 1.0 nm, at least 2.0 nm, at least 3.0 nm, at least 4.0 nm, at least 5.0 nm, and/or
at most 25 nm, at most 10 nm or at most 8.0 nm.

Preferably, the dielectric coating directly below the silver-based metal functional layer comprises at least one dielectric layer having a barrier function. Dielectric layers having a barrier function (hereinafter barrier layer) is understood to mean a layer made of a material capable of forming a barrier to the diffusion of oxygen and water at high temperatures, originating from the ambient atmosphere or from the transparent substrate, toward the functional layer. Such dielectric layers are selected from layers:
based on silicon and/or aluminum and/or zirconium compounds selected from oxides such as SiO2, nitrides such as silicon nitride Si3N4 and aluminum nitrides AlN, and oxynitrides SiOxNy, optionally doped with at least one other element,
based on zinc-tin oxide,
based on titanium oxide.

Preferably, the first dielectric coating comprises at least one dielectric layer based on:
an aluminum and/or silicon and/or zirconium nitride or oxynitride, or
a mixed oxide of zinc and tin, or
titanium oxide.

Preferably, the first dielectric coating comprises:
a layer based on an aluminum and/or silicon and/or zirconium nitride or oxynitride, and/or
a layer based on a mixed oxide of zinc and tin, and/or
a layer based on a nitride or oxynitride of aluminum and/or silicon and/or zirconium and a dielectric layer based on a mixed oxide of zinc and tin located above, preferably in contact with, the layer based on a nitride or oxynitride of aluminum and/or silicon and/or zirconium.

The layer based on zinc tin oxide is located below, preferably in contact with, the oxide-based layer.

These dielectric layers having a barrier function have, in ascending order of preference, a thickness:
less than or equal to 40 nm, less than or equal to 30 nm, less than or equal to 25 nm, and/or
greater than or equal to 5 nm, greater than or equal to 10 nm or greater than or equal to 15 nm.

The electroconductive substrate coated with the coating, or the coating alone, might not have undergone a heat treatment. The present invention relates to non-heat-treated material or heat-treated material.

The electroconductive coating might not have undergone a heat treatment at a temperature of greater than 500° C., preferably 300° C.

The coating might have had to undergo a heat treatment at a temperature above 300° C., preferably 500° C. In this case, the heat treatments are chosen from annealing, for example by a rapid thermal process such as laser annealing or flash lamp annealing, tempering and/or bending. The rapid thermal annealing is for example described in application WO2008/096089. The heat treatment temperature (at the coating) is greater than 300° C., preferably greater than 400° C. and better still greater than 500° C.

The substrate coated with the coating can be is a bent or tempered glass.

The transparent substrates according to the invention are preferably made of a rigid inorganic material, such as made of glass, or are organic, based on polymers (or made of polymer).

The organic transparent substrates according to the invention can also be made of polymer, and are rigid or flexible. Examples of suitable polymers according to the invention particularly comprise:
polyethylene,
polyesters such as polyethylene terephthalate (PET), polybutylene terephthalate (PBT), polyethylene naphthalate (PEN);
polyacrylates such as polymethyl methacrylate (PMMA);
polycarbonates;
polyurethanes;
polyamides;
polyimides;
fluorinated polymers such as fluoresters like ethylene tetrafluoroethylene (ETFE), polyvinylidene fluoride (PVDF), polychlorotrifluoroethylene (PCTFE), ethylene chlorotrifluoroethylene (ECTFE), fluorinated ethylene-propylene copolymers (FEP);
photocrosslinkable and/or photopolymerizable resins, such as thiol-ene, polyurethane, urethane-acrylate, polyester-acrylate; and
polythiourethanes.

The substrate is preferably a sheet of glass or of glass-ceramic.

The substrate is preferably transparent, colorless (it is then a clear or extra-clear glass) or colored, for example blue, gray or bronze. The glass is preferably soda-lime-silica type but it can also be a glass of borosilicate or alumino-borosilicate type.

According to a preferred embodiment, the substrate is made of glass, especially soda-lime-silica glass, or of polymer organic material.

Advantageously, the substrate has at least one dimension greater than or equal to 1 m, or even 2 m or even 3 m.

The thickness of the substrate generally ranges from 0.05 mm to 19 mm. When the substrate is mineral, its thickness is preferably between 0.7 and 9 mm, particularly between 2 and 8 mm, or even between 4 and 6 mm. The substrate can be flat or curved, or even flexible. When the substrate is organic, its thickness is preferably between 1 and 2 mm.

### EXAMPLES

### I. Electroconductive Coatings

Electroconductive coatings were sputtered onto a transparent glass substrate. The glass substrates are 2.1 mm aluminosilicate glass substrates.

The functional layers (F) are silver-based metal layers.

The dielectric coatings comprise:
silicon nitride-based coatings,
zinc-tin oxide layers,
aluminum-doped zinc layers,
indium-tin layers.

The blocking layers are selected from titanium, titanium nitride, nickel-chromium, and zinc layers.

The conditions for deposition of the layers, which were deposited by sputtering (“magnetron cathode” sputtering), are summarized in table 1.

TABLE 1

| Layer | Target used | Pressure Pa | Gas |
|---|---|---|---|
| ITO | In₂O₃ 90%, SnO₂ 10% | 0.2 | Ar/(Ar + O2) at 99% |
| | wt | | |
| Zn | Zn | 0.2 | Ar at 100% |
| NiCr | Ni:Cr at 80%:20% by | 0.2 | Ar at 100% |
| | weight | | |
| TiN | Ti | 0.1 to 1 | Ar 85%-N2 15% |
| Ti | Ti | 0.1 to 1 | Ar at 100% |
| Ag | Ag | 0.1 to 1 | Ar at 100% |
| SnZnO | Zn:Sn (64:36% by wt) | 0.1 to 1 | Ar/(Ar + O₂) at 50% |
| Si3N4 | Si:Al (92:8% by wt) | 0.32 | Ar/(Ar + N2) at 55% |

Table 2 lists the materials for each layer or coating that forms the coatings as a function of their position with respect to the substrate bearing the stack (final line at the bottom of the table).

TABLE 2

| | | Coa. 1 | Coa. 2 | Coa. 3 | Coa. 4 | Coa. 5 | Coa. 6 | Coa. 7 |
|---|---|---|---|---|---|---|---|---|
| Upper DC | ITO | — | 60 | 35 | 35 | 35 | — | — |
| | AZO | 60 | — | 60 | 60 | 60 | 60 | 60 |
| | Zn | — | — | — | — | — | — | — |
| BL | Ti | 0.5 | 0.5 | 1 | — | — | — | — |
| | TiN | — | — | — | 1 | — | — | — |
| | NiCr | — | — | — | — | 1 | 1 | — |
| | Zn | — | — | — | — | — | — | 2 |
| FC | Ag | 10 | 10 | 10 | 10 | 10 | 10 | 10 |
| Lower DC | AZO | 5 | 5 | 5 | 5 | 5 | 5 | 5 |
| | SnZnO | 5 | 5 | 5 | 5 | 5 | 5 | 5 |
| | Si3N4 | 20 | 20 | 20 | 20 | 20 | 20 | 20 |
| Substrate | glass | 2 mm | 2 mm | 2 mm | 2 mm | 2 mm | 2 mm | 2 mm |

The first dielectric coatings comprise a SiN/SnZnO/ZnO sequence to prevent diffusion of chemical species from the substrate, reduce surface roughness, and optimize silver quality.

The coatings have not been heat-treated at high temperatures.

### II. Determination of Electrochemical Properties

To determine the electrochemical properties of conductive coatings in relation to mobile electrolyte species such as Li/Li+, voltammetric cycles were carried out. To achieve this, the current response resulting from a continuous variation in the potential of the electroconductive coating (used as the working electrode) on which the electrochemical reaction under study takes place is measured.

The figures show voltammetric cycles based on a three-electrode set-up with a lithium metal counter-electrode, a lithium metal reference electrode, and a working electrode with the various electroconductive coatings. The electrolyte is a LiClO4/PC solution.

The voltammograms were taken in the potential window from 2 to 4 V with respect to Li/Li+ at a scan rate of 2 mV/s.

### 1. Nature of the Dielectric Layers of the Upper Dielectric Coating

Electroconductive coatings 1, 2, and 3 differ in the choice of the conductive oxide layer(s) making up the upper dielectric coating.

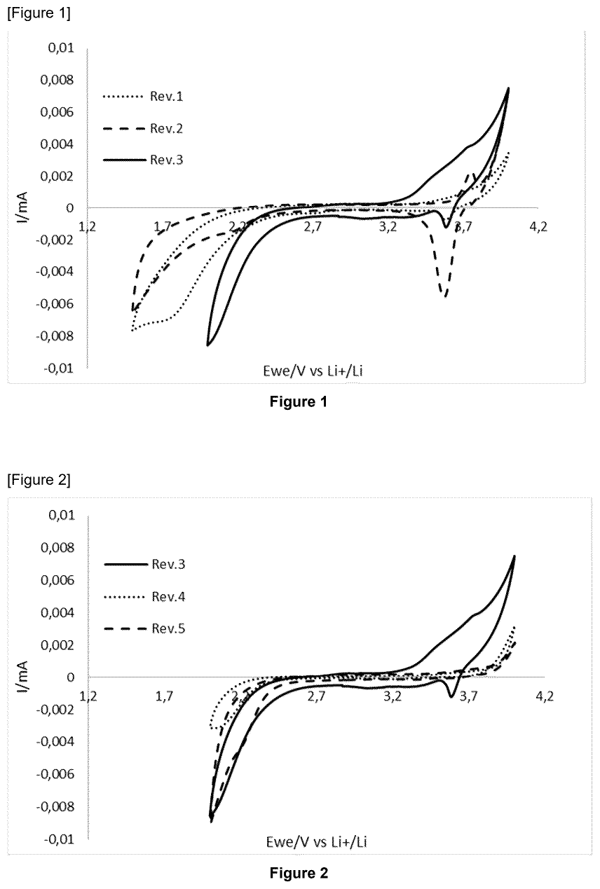

The electroconductive coatings tested in FIG. 1 have not been heat-treated. On this graph, coating degradation is observed with an oxidation peak and a reduction peak, as well as the rise in current above 3.4 V vs Li/Li+.

However, this phenomenon is less marked when using a conductive oxide layer based on aluminum-doped zinc oxide. This is reflected in a lower peak for Coating 1 than for Coating 2 or Coating 3. Consequently, the electrically conductive coating of the invention preferably comprises at least one aluminum-doped zinc oxide layer with a thickness greater than 40 nm or greater than 50 nm.

### 2. Nature of the Blocking Layers

### 1. No Heat Treatment

Coatings 4 and 5 differ from coating 3 in the nature of the blocking layer (TIN and NiCr versus Ti respectively). FIG. 2 shows the voltammogram cycles for these 3 coatings in the absence of heat treatment.

Changing the metal blocking layer from Ti to TiN or NiCr has a strong impact on the electrochemical window of the silver. Current rise above 3.4V vs Li/Li+ is much lower, and oxidation or reduction peaks around 3.6-3.7V vs Li/Li+ are no longer observed. The electrode coating is compatible with EC devices working in the 2-4V vs Li/Li+ range.

The NiCr and TiN layers act as an effective shield against any degradation of the silver layer that may occur during subsequent layer deposition (cathode sputtering), high-temperature annealing and/or subsequent electrochemical reaction.

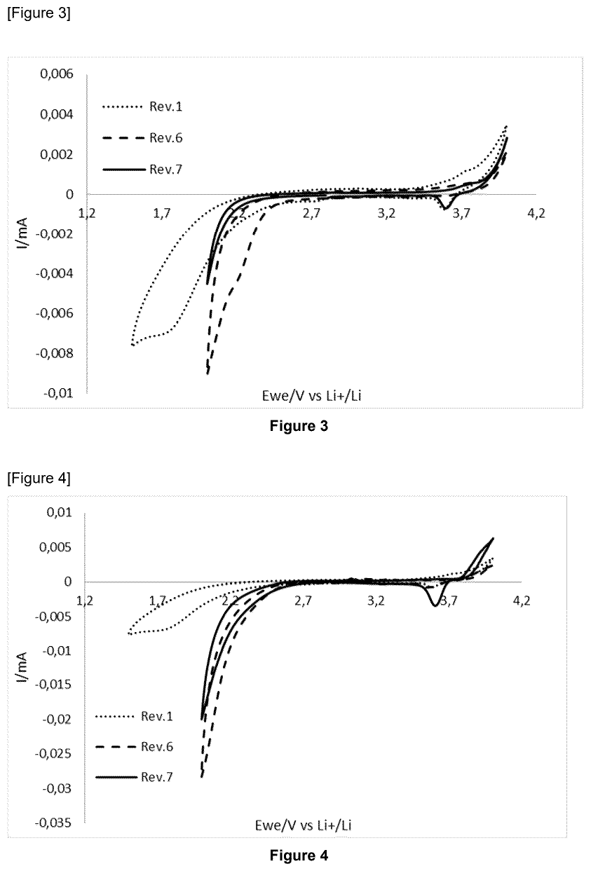

Coating 6, Coating 7 and Coating 1 differ in the nature of the blocking layer (NiCr, Zn and Ti respectively). FIG. 3 shows the voltammogram cycles for these 3 coatings.

No heat treatment was carried out.

The presence of a blocking metal layer based on zinc or titanium in the vicinity of the silver layer shows no positive effect. The presence of redox peaks indicates electrode degradation.

Coating 6 has good electrochemical stability. There is very little current rise above 3.4 V and no oxidation-reduction peak.

The invention makes it possible to use the silver-based coating in a high-contrast electrochromic device operating in the 2-4V vs Li/Li+ range.

### 2. After Heat Treatment

After heat treatment at 600° C. for 8 minutes, redox peaks are observed for Coating 1, Coating 7 and Coating 6. FIG. 4 shows the voltammogram cycles for these 3 coatings after heat treatment.

In the case of coating 7, which comprises a metallic zinc blocking layer, this phenomenon is particularly significant. An increase in current above 3.4 V is observed, as are oxidation-reduction peaks at 3.6 and 3.7 V. After heat treatment, the presence of a metallic zinc layer alone does not improve the electrochemical stability of silver.

For Coating 6 with a NiCr-based blocking layer, the positive impact of this layer is weaker in the event of heat treatment.

1. A material comprising a substrate coated with a first coating comprising, starting from the substrate:
a first dielectric coating,
a silver-based metal functional layer,
a blocking layer located above and immediately in contact with the silver-based metal functional layer, said blocking layer being chosen from metal layers of one or more elements chosen from nickel and chromium and metal nitride layers of one or more elements chosen from titanium, nickel and chromium,
a second dielectric coating comprising at least one conductive oxide layer, a sum of thicknesses of the conductive oxide layers in the second dielectric coating being greater than 40 nm.

2. The material according to claim 1, wherein the blocking layer has a thickness of between 0.1 and 5.0 nm.

3. The material according to claim 1, wherein the blocking layer is selected from a titanium nitride layer, nickel-based metal layers and/or chromium-based metal layers

4. The material according to claim 1, wherein the second dielectric coating comprises a conductive oxide layer selected from mixed tin and indium oxide, indium tin oxide, doped zinc oxide, doped ruthenium oxide, and fluorine-doped tin oxide.

5. The material according to claim 1, wherein the second dielectric coating comprises a conductive oxide layer selected from mixed tin and indium oxide or zinc oxide doped with aluminum and/or gallium.

6. The material according to claim 1, wherein the second dielectric coating comprises a conductive oxide layer based on aluminum-doped zinc oxide with a thickness greater than 50 nm.

7. The material according to claim 1, wherein the first dielectric coating comprises at least one crystallized dielectric layer optionally doped using at least one other element.

8. The material according to claim 7, wherein the crystallized dielectric layer has a thickness of 2 to 15 nm.

9. The material according to claim 1, wherein the first dielectric coating comprises:
a layer based on aluminum and/or zirconium silicon nitride or oxynitride, and/or
a zinc-tin oxide layer.

10. The material according to claim 1, wherein the substrate is made of glass or of polymer organic material.

11. An electrochromic system comprising:
a material comprising a substrate coated with a first coating comprising, starting from the substrate:
a first dielectric coating,
a silver-based metal functional layer,
a blocking layer located above and immediately in contact with the silver-based metal functional layer, said blocking layer being chosen from metal layers of one or more elements chosen from nickel and chromium, and metal nitride layers of one or more elements chosen from titanium, nickel and chromium,
a second dielectric coating comprising at least one conductive oxide layer, a sum of the thicknesses of the conductive oxide layers being greater than 40 nm,
a first active layer comprising an electrochromic material,
an electrolyte layer,
a second active layer and
a second transparent electroconductive coating,
optionally a substrate.

12. The material according to claim 1, wherein the blocking layer is made of Ni, Cr, NiCr, NiN, CrN, NiCrN, TiN.

13. The material according to claim 7, wherein the at least one crystallized dielectric layer is based on zinc oxide.

14. The material according to claim 7, wherein the at least one other element is aluminum.

15. The material according to claim 8, wherein the crystallized dielectric layer is based on zinc oxide.

16. The material according to claim 10, wherein the substrate is made of soda-lime-silica glass.

17. The An electrochromic system according to claim 11, wherein the blocking layer is made of Ni, Cr, NiCr, NiN, CrN, NiCrN, TiN.
